(19) United States
(12) Patent Application Publication
(10) Pub. No.: US 2023/0191437 A1
(43) Pub. Date: Jun. 22, 2023

(54) Discharge Apparatus for Air Vehicle

(71) Applicant: TOYO SEIKAN CO., LTD., Tokyo (JP)

(72) Inventors: Atsushi Kominami, Yokohama-shi, Kanagawa (JP); Souji Araki, Yokohama-shi, Kanagawa (JP)

(21) Appl. No.: 17/925,865

(22) PCT Filed: May 18, 2021
(86) PCT No.: PCT/JP2021/018735

§ 371 Date: Nov. 17, 2022

(30) Foreign Application Priority Data
May 19, 2020 (JP) 2020-087355

(51) Int. Cl. B05B 13/04; B64U 20/70; B05B 12/12

(52) U.S. Cl. CPC B05B 13/0421; B64U 20/70; B05B 12/124; B64U 2101/45

(57) ABSTRACT

Provided is a discharge apparatus for an air vehicle, capable of reducing a loss of discharge pressure from an aerosol container. The discharge apparatus for an air vehicle discharges contents from an aerosol container 10 mounted on an airframe 101 through a nozzle 15. The aerosol container 10 is mounted on an exterior of the airframe 101, and one end of the nozzle 15 is supported by a discharge end part of the aerosol container 10 via a pipe joint 17 that allows the nozzle 15 to rotate so as to be rotatable around at least one rotation axis M.

### TECHNICAL FIELD

The present invention relates to a discharge apparatus for an air vehicle, the discharge apparatus discharging liquid, gas, air, sound (horn), or the like from the air vehicle such as an unmanned air vehicle. In particular, the present invention relates to a discharge apparatus for an air vehicle, the discharge apparatus including an aerosol container that ejects contents by gas pressure.

### BACKGROUND ART

Conventionally, as an example of a discharge apparatus for an air vehicle that uses this type of aerosol container, a bee extermination apparatus as described in PTL 1 is known. This bee extermination apparatus includes a pesticide supply unit inside its airframe to supply pesticide to bee nests, and an aerosol container is attached to this pesticide supply unit as a jetting instrument. The pesticide supply unit includes an aerosol container and an electromagnetic switching valve arranged inside the air vehicle and a cylindrical part (nozzle) provided with an attitude control unit arranged outside the air vehicle and is configured to control the angle of the cylindrical part.

### CITATION LIST

### Patent Literature

[PTL 1] Japanese Patent Application Publication No. 2017-104063

### SUMMARY OF INVENTION

### Technical Problem

However, the unmanned air vehicle described in PTL 1 has a long transportation path from the aerosol container to the cylindrical part inside the air vehicle, and a liquid loss and a pressure loss occur in the transportation path, resulting in a decrease in discharge pressure. In a case of the aerosol container, since liquid is discharged by the internal pressure of the container, the pressure loss is a problem.

The present invention has been made to solve the above problems in the prior art described above, and an object of the present invention is to provide a discharge apparatus for an air vehicle capable of reducing a loss of discharge pressure from an aerosol container as much as possible.

### Solution to Problem

In order to achieve the above object, the present invention provides a discharge apparatus for an air vehicle, the discharge apparatus discharging contents from an aerosol container mounted on an airframe through a nozzle, wherein the aerosol container is mounted on an exterior of the airframe and one end of the nozzle is supported by a discharge end part of the aerosol container via a pipe joint that allows the nozzle to rotate so as to be rotatable around at least one rotation axis.

According to the present invention, the nozzle is rotatably connected to the discharge end part of the aerosol container via a pipe joint member that allows the nozzle to rotate. This eliminates the need for a tube or the like for transporting the contents to the nozzle, and the transportation path of the contents from the aerosol container is shortened so that a loss of discharge pressure can be reduced as much as possible.

In addition, the discharge end part of the aerosol container and the nozzle are connected with a pipe joint, that is, the flow passages of the contents can be connected only by this pipe joint.

The present invention can be configured as follows.

1. The discharge end part of the aerosol container is an actuator connected to a stem of the aerosol container.
2. The nozzle has one rotation axis.

For example, the nozzle can be configured to rotate up and down around a horizontal rotation axis or to rotate from side to side with respect to a vertical rotation axis. As a result of configuring the nozzle to rotate up and down or from side to side, the rotation direction corresponds to the elevation angle, the depression angle, or azimuth angle of the nozzle so that the control direction is made clear, which facilitates the operation by the operator.

The direction of the rotation axis is not limited to the vertical or horizontal direction but may be inclined at a predetermined angle with respect to the horizontal or vertical direction.

3. The nozzle can have two rotation axes whose directions are different from each other and that allow the nozzle to rotate in two directions.

As a result of allowing the nozzle to rotate in two directions, for example, a configuration in which the nozzle rotates vertically and horizontally is achieved by setting the rotation axes in the horizontal direction and the vertical direction. Thus, all the elevation angle, the depression angle, and the azimuth angle of the nozzle can be controlled.

4. The individual rotation axis of the nozzle is set in a perpendicular direction with respect to a centerline of the aerosol container.

For example, in a case where the aerosol container is horizontally loaded such that the centerline thereof is parallel to a roll axis of the airframe, when the rotation axis of the nozzle is horizontally set, the nozzle rotates up and down, and when the rotation axis is vertically set, the nozzle rotates from side to side.

Further, in a case where the aerosol container is vertically loaded such that the centerline thereof is parallel to a yaw axis of the airframe, the nozzle rotates up and down.

5. The rotation axis of the nozzle may be offset in a perpendicular direction with respect to the centerline of the aerosol container.

As a result of having an offset rotation axis, the contents can be discharged in a range away from the centerline of the aerosol container.

6. The offset rotation axis of the nozzle is located outside a maximum-diameter portion of the aerosol container.

As a result, the discharge can be performed directing backward of the aerosol container.

7. The discharge apparatus includes nozzle driving means for rotating the nozzle.

As a result, the angle of the nozzle can be automatically adjusted.

8. The aerosol container mounted on the airframe is supported with respect to the airframe so as to be rotatable around a turning axis in a direction parallel to a yaw axis, and the turning axis and the rotation axis of the nozzle are separated from each other by a predetermined distance.

For example, the aerosol container rotates around the turning axis with respect to the airframe so as to direct the discharge end part of the aerosol container toward a discharge target, and at this orientation, the nozzle rotates around the rotation axis to be accurately directed at the discharge target. As a result, the nozzle can be directed to the discharge target regardless of the orientation of the air vehicle.

9. The discharge apparatus includes container driving means for driving the aerosol container to rotate with respect to the airframe.

As a result, the orientation of the aerosol container and the angle of the nozzle can be automatically adjusted.

10. The aerosol container can be horizontally loaded such that a centerline of the aerosol container is arranged in a direction parallel to a roll axis of the airframe.
11. The aerosol container can also be vertically loaded such that a centerline of the aerosol container is arranged in a direction parallel to a yaw axis of the airframe.

For example, in the case where the aerosol container is horizontally loaded, a separation-type aerosol container is used. In this case, as the amount of contents of the aerosol container decreases, the space occupied by the contents moves sideways, thereby moving the position of the center of gravity sideways. As a result, the stability of the airframe is disturbed. In contrast, in the case where the aerosol container is vertically loaded, even when the amount of contents of the separation-type container decreases, the position of the center of gravity only moves vertically. As a result, the airframe can maintain the stability so that the discharge direction can be stabilized.

12. The aerosol container can be configured to be housed in a housing member.

As a result of using a housing member, a pipe joint that rotatably supports the nozzle can be supported by using the housing member.

13. The housing member is provided with a discharge driving unit for causing contents of the aerosol container to be discharged.

As a result of providing the housing member with the discharge driving unit, a mechanism suitable for the size, shape, and weight of the aerosol container can be selected. Thus, an optimal structure for the aerosol container can be achieved.

14. The discharge driving unit has a configuration in which, by moving a container main body of the aerosol container, a stem protruding from the container main body is pushed into the container main body so that the contents are discharged.

Since the aerosol container in the state of being housed in the housing member is moved, the position of the components on the actuator side can be constantly maintained so that the position of the rotatable pipe joint, that is, the position of the rotation axis does not change.

15. The nozzle holds a camera.

As a result of holding a camera in the nozzle, the image-capturing direction of the camera automatically matches the discharge direction of the nozzle so that the direction of the camera does not need to be controlled.

16. The nozzle holds a distance sensor.

As a result of holding a distance sensor in the nozzle, a distance to a target object in the discharge direction of the nozzle can be accurately measured.

### Advantageous Effects of Invention

According to the present invention, the transportation path of the contents from the aerosol container is shortened so that a loss of discharge pressure can be reduced as much as possible.

### BRIEF DESCRIPTION OF DRAWINGS

FIG. 1 conceptually illustrates a discharge apparatus for an air vehicle according to Embodiment 1 of the present invention. FIG. 1(A) is a perspective view illustrating an overall configuration of the air vehicle, FIG. 1(B) is a perspective view of a sleeve viewed diagonally from the front, FIG. 1(C) is a horizontal cross-sectional view illustrating the vicinity of a nozzle, and FIG. 1(D) is an enlarged cross-sectional view schematically illustrating the vicinity of a swivel pipe joint.

FIG. 2(A) is a vertical cross-sectional view taken along the center of the discharge apparatus in FIG. 1, FIG. 2(B) is a horizontal cross-sectional view taken along the center of the discharge apparatus in FIG. 2(A), and FIG. 2(C) is a vertical cross-sectional view taken along the center of the discharge apparatus in a state where the nozzle is inclined downward.

FIG. 3 illustrates an example of a valve mechanism of an aerosol container in FIG. 2.

FIG. 4 illustrates another method of a discharge driving unit.

FIG. 5(A) is an explanatory diagram illustrating an example of a maneuvering terminal and an operating terminal conducting remote-control operations of the air vehicle on which the discharge apparatus is mounted, and FIG. 5(B) illustrates a control block diagram.

FIG. 6 conceptually illustrates a discharge apparatus for an air vehicle according to Embodiment 2 of the present invention. FIG. 6(A) is a perspective view illustrating an overall configuration of the air vehicle, and FIG. 6(B) is a perspective view of a sleeve viewed diagonally from the front.

FIG. 7(A) is a cross-sectional view illustrating a configuration example of a rotation support unit in FIG. 6, and FIG. 7(B) is a top view illustrating a rotating state of an aerosol container assembly.

FIG. 8 illustrates a discharge apparatus for an air vehicle according to Embodiment 3 of the present invention. FIG. 8(A) is a perspective view of a sleeve viewed diagonally from the front, FIG. 8(B) is a side view illustrating the vicinity of a nozzle attachment portion, and FIG. 8(C) is a top view illustrating the vicinity of the nozzle attachment portion.

FIG. 9(A) is a perspective view of a discharge apparatus for an air vehicle according to Embodiment 4 of the present invention when viewed diagonally from the front, and FIG. 9(B) is a side view illustrating the vicinity of a nozzle.

FIG. 10 conceptually illustrates a discharge apparatus for an air vehicle according to Embodiment 5 of the present invention. FIG. 10(A) is a perspective view illustrating an overall configuration of the air vehicle, FIG. 10(B) is a cross-sectional view of the discharge apparatus, and FIG. 10(C) is a cross-sectional view illustrating a state in which a nozzle of the discharge apparatus in FIG. 10(B) is directed backward.

FIG. 11 is an exploded cross-sectional view of an aerosol assembly in FIG. 10.

FIG. 12 conceptually illustrates a discharge apparatus for an air vehicle according to Embodiment 6 of the present invention. FIG. 12(A) is a perspective view illustrating an overall configuration of the air vehicle, and FIG. 12(B) is a cross-sectional view of the discharge apparatus.

FIG. 13 conceptually illustrates a discharge apparatus for an air vehicle according to Embodiment 7 of the present invention. FIG. 13(A) is a cross-sectional view illustrating a state in which a nozzle is directed forward, and FIG. 13(B) is a cross-sectional view illustrating a state in which a nozzle is directed downward.

FIG. 14(A) is a side view illustrating a discharge apparatus for an air vehicle according to Embodiment 8 of the present invention, and FIG. 14(B) is a side view illustrating a discharge apparatus for an air vehicle according to Embodiment 9 of the present invention.

FIG. 15(A) is a perspective view illustrating an example of a discharge apparatus in which a camera is attached to a nozzle, and FIG. 15(B) is a perspective view illustrating an example of a discharge apparatus in which a distance sensor is attached to a nozzle.

### DESCRIPTION OF EMBODIMENTS

Hereinafter, the present invention will be described in detail based on the embodiments illustrated in the drawings.

Dimensions, materials, shapes, relative arrangements, and the like of components described in the following embodiments are to be changed as appropriate according to a configuration and various conditions of an apparatus to which the invention is applied and are not intended to limit the scope of the invention to the following embodiments.

### Embodiment 1

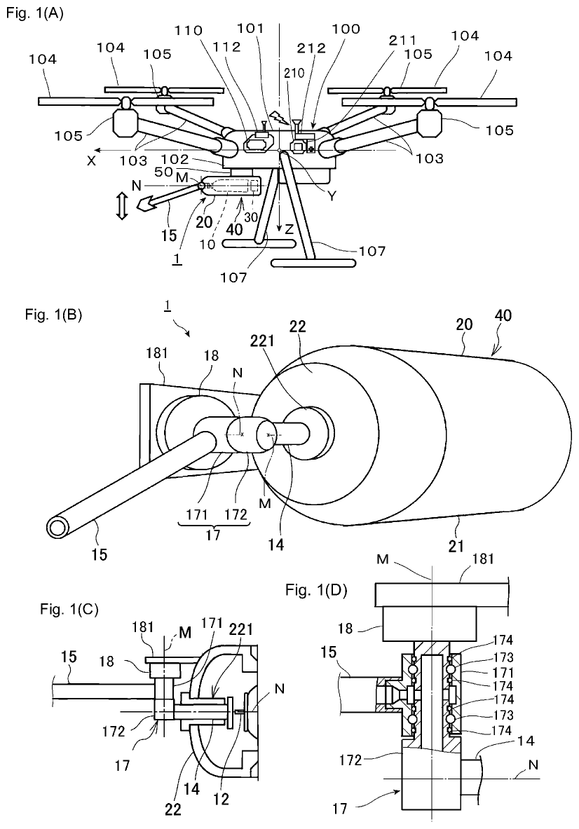

FIG. 1 conceptually illustrates a discharge apparatus for an air vehicle according to Embodiment 1 of the present invention. FIG. 1(A) is a perspective view illustrating an overall configuration of the air vehicle, FIG. 1(B) is a perspective view of the discharge apparatus viewed diagonally from the front, FIG. 1(C) is a horizontal cross-sectional view illustrating the vicinity of a nozzle, and FIG. 1(D) is a cross-sectional view schematically illustrating a swivel pipe joint.

FIG. 1(A) illustrates a discharge apparatus 1 and an air vehicle 100 on which the discharge apparatus 1 is mounted. The air vehicle 100 is an unmanned aerial vehicle such as a so-called multicopter. An airframe 101 includes an airframe body 102, four arms 103 radially extending from the airframe body 102, and legs 107 for takeoff and landing. Four rotors 104 are provided at the respective ends of the arms 103 via respective motors 105. In the illustrated example, a quadcopter with four rotors 104 is illustrated. However, various known multicopters such as a tricopter with three rotors and a hexacopter with six rotors are applicable. In the drawings, a yaw axis, a roll axis, and a pitch axis of the air vehicle 100 are denoted by Z, X, and Y, respectively. It is assumed that the upper side of the paper along the yaw axis Z is an upward direction, the lower side of the paper along the yaw axis Z is a downward direction, the left side of the paper along the roll axis X is a forward direction, and the right side of the paper along the roll axis X is a backward direction.

The discharge apparatus 1 includes an aerosol container 10, a sleeve 20 that houses the aerosol container 10, a nozzle 15 that is connected to a discharge end part of the aerosol container 10, and a discharge driving unit 30 and is configured to discharge contents from the aerosol container 10 through the nozzle 15. The aerosol container 10 is connected to the lower surface of the airframe body 102 via a connecting part 50 in a state of being housed in the sleeve (housing member) 20. In the following description, an assembly in a state where the aerosol container 10 is housed in the sleeve 20 is referred to as an aerosol container assembly 40.

The aerosol container 10 is mounted in a horizontally loaded state, in which the aerosol container 10 is laid in the front-to-back direction with its top portion pointed to the front and its centerline N (hereinafter, referred to as a container centerline N) set parallel to the roll axis X of the air vehicle 100.

The nozzle 15 is a linear member and is rotatably supported around a rotation axis M so that the angle of the nozzle 15 is adjustable. In this example, the rotation axis M extends in a direction perpendicular to the container centerline N and is arranged so as to be parallel to the pitch axis Y. When the air vehicle 100 is in a horizontal state, the rotation axis M is horizontal. Thus, the nozzle 15 vertically rotates around the rotation axis M on a plane parallel to the XZ plane passing the roll axis X and the yaw axis Z so that the angle (elevation or depression angle) of the nozzle can be adjusted. In the illustrated example, the aerosol container 10 is mounted near the front on the lower surface of the airframe body 102, and the front end portion of the aerosol container 10 protrudes forward from the front end of the airframe body 102. Thus, the nozzle 15 can rotate upward without interfering with the airframe body 102, achieving a wide movable range.

The rotation axis M of the nozzle 15 is not limited to be set in the horizontal direction but may also be set in the vertical direction to allow the nozzle to rotate from side to side. As described above, by configuring the nozzle to rotate up and down or from side to side, the rotation direction corresponds to the elevation angle, the depression angle, or azimuth angle of the nozzle, which facilitates the operation by the operator. However, the direction of the rotation axis M is not limited to the vertical or horizontal direction but may be inclined at a predetermined angle with respect to the horizontal or vertical direction. Since the aerosol container assembly 40 is in a horizontally loaded state in the present embodiment, the rotation axis M can be set by changing the phase of the rotational direction around the container centerline N.

Next, a support structure of the nozzle 15 will be described in detail with reference to FIGS. 1(B) and 1(C).

As illustrated in FIGS. 1(B) and 1(C), the nozzle 15 is connected to an actuator 14 protruding from a first end cover part 22 of the sleeve 20 via a swivel pipe joint 17, which is a rotatable pipe joint member having the rotation axis M described above. The actuator 14 is a linear member inserted into the sleeve 20 through a pressing member 221 fixed to the first end cover part 22, and the end portion of the actuator 14 inside the sleeve 20 is connected to a stem 12 of the aerosol container 10 housed in the sleeve 20 to configure a discharge end part of the aerosol container 10. The actuator 14 functions as a discharge button by pushing the stem 12 in to discharge contents. While FIG. 1(C) illustrates a state in which the actuator 14 and the stem 12 are separated from each other, the aerosol container 10 moves toward the actuator 14 side at the time of discharging, thereby pushing the stem 12 against the actuator 14 so that the stem 12 is connected to the actuator 14, as will be described below.

The swivel pipe joint 17 allows the nozzle 15 to rotate while maintaining a connected state of the flow passage between the nozzle 15 and the actuator 14 of the aerosol container 10. The swivel pipe joint 17 includes a first joint member 171 and a second joint member 172 arranged in series along the rotation axis M, and an end portion of the nozzle 15 is connected to the first joint member 171, and the actuator 14 is connected to the second joint member 172. The actuator 14 is connected to the second joint member 172 in a direction perpendicular to the rotation axis M. The nozzle 15 is a linear member and is connected to the first joint member 171 in a direction perpendicular to the rotation axis M. Although the swivel pipe joint 17 itself has a rotational range of 360°, the rotation of the nozzle 15 in the upward direction is limited by the interference with the sleeve 20 or the airframe body 102, and the rotation in the downward direction is limited by the interference with the sleeve 20.

A motor 18 constituting nozzle driving means is operatively connected to the first joint member 171 of the swivel pipe joint 17, and by rotationally driving the first joint member 171, the rotation angle of the nozzle 15 can be adjusted. The motor 18 is supported by a support frame 181 fixed to the first end cover part 22 of the sleeve 20. The motor 18 rotates the nozzle 15 and holds the position of the nozzle 15 at a target angle so as not to be moved. A brake, a clutch, or the like may be provided to hold the rotational position, or the motor 18 itself may hold the rotational position.

As the driving means for the nozzle 15, a simplified configuration is adopted so that the motor 18 is directly connected. However, various configurations may be adopted. For example, a transmission mechanism such as gears may be provided between the motor 18 and the first joint member 171, or a clutch mechanism may be provided.

As schematically illustrated in FIG. 1(D), in the swivel pipe joint 17, the cylindrical first joint member 171 and second joint member 172 are rotatably fitted to each other via rolling bodies 173 such as balls. A clearance between the first joint member 171 and the second joint member 172 is sealed by seal members 174 so that leakage of contents is prevented. In the illustrated example, a rolling contact structure using the rolling bodies 173 is adopted. Alternatively, a sliding contact structure may be adopted.

In the present embodiment, the nozzle 15 is rotatably connected to the actuator 14 of the aerosol container 10 via the swivel pipe joint 17. This eliminates the need for a tube or the like for transporting the contents to the nozzle 15, and the transportation path of the contents from the aerosol container 10 is shortened so that a loss of discharge pressure can be reduced as much as possible.

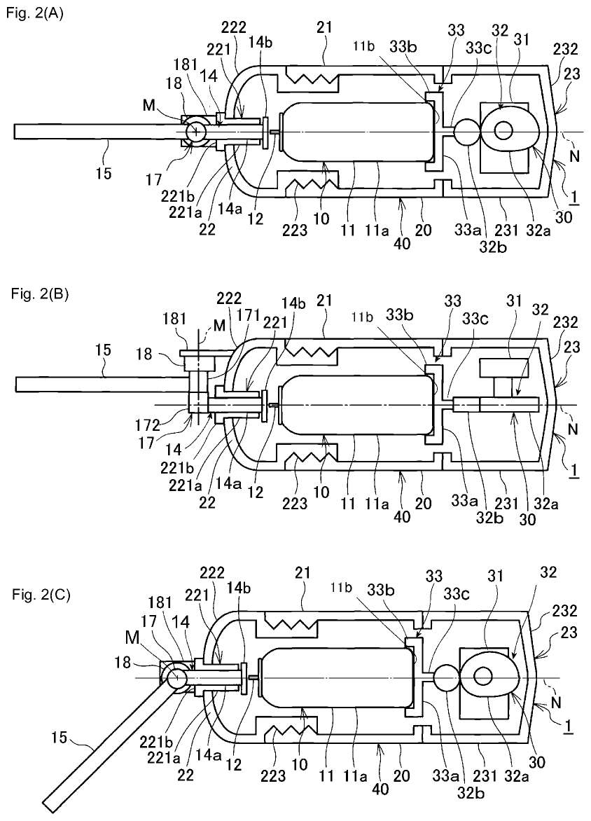

Next, a configuration of the aerosol container assembly 40 will be described in detail with reference to FIG. 2.

FIG. 2 illustrates cross-sectional views of the aerosol container assembly. FIG. 2(A) is a vertical cross-sectional view taken along a plane that is perpendicular to the rotation axis of the nozzle and passes the container centerline. FIG. 2(B) is a horizontal cross-sectional view taken along a plane that has a different phase by 90° from the plane in FIG. 2(A). FIG. 2(C) is a vertical cross-sectional view illustrating a state in which the nozzle is inclined downward.

As described above, the aerosol container 10 is housed in the sleeve 20 and mounted on the exterior of the airframe 101 as the aerosol container assembly 40 for discharging the contents of the aerosol container 10 from below the airframe 101. Examples of the contents to be discharged include not only liquid but also gas, a gaseous body such as air, powder, and the like, and further include a case of discharging sound (horn) or the like. For example, the discharge of sound is configured such that a sound is created by ejecting gas.

A discharge driving unit 30 for discharging the contents from the aerosol container 10 is built inside the sleeve 20. The sleeve 20 and the aerosol container 10 are replaceable as one unit.

Hereinafter, the configuration of each part will be described.

### [Aerosol Container]

The aerosol container 10 is a container that ejects contents by gas pressure of liquefied gas or compressed gas filled therein, and an existing aerosol container made of metal can be applied, or a container made of plastic having pressure resistance can be used. An actuator having a flow passage formed based on a discharge direction or a discharge pattern is attached to the stem 12 protruding from a container main body 11 of the aerosol container 10. In the illustrated example, the actuator 14 having a flange portion 14b is attached to the stem 12 of the aerosol container 10. The actuator 14 includes a linear actuator main body portion 14a having a straight discharge passage and the flange portion 14b protruding from the actuator main body portion 14a in a direction perpendicular to the axis of the actuator 14. The flow passage configuration of the actuator 14 is appropriately selected in accordance with the discharge pattern and the discharge direction of the contents, for example, whether to discharge the contents in a mist form or a linear jet flow.

In Embodiment 1, since the aerosol container 10 is mounted on the airframe 101 in a horizontally loaded state such that the container centerline N of the aerosol container 10 is parallel to the roll axis X, a propellant and contents are encapsulated in a container in a separated manner, that is, the insecticidal solution is stored in an inner bag, and the propellant is stored between the outer periphery of the inner bag and the inner periphery of the container main body. By using the separation-type container, the contents can be discharged even when the aerosol container is held in a sideways position (the stem faces sideways) or in a downward position (the stem faces downward).

However, when the aerosol container 10 is not mounted horizontally as in Embodiment 1, the container is not limited to the separation type. For example, when the aerosol container 10 is mounted in a vertically loaded configuration such that the container centerline N is parallel to the yaw axis Z and is used with the stem 12 facing upward, a two-phase or three-phase container provided with a dip tube can be applied. Further, when the aerosol container 10 is used with the stem 12 facing downward, a two-phase or three-phase container provided with no dip tube can be applied.

As the propellant, a liquefied gas such as a common hydrocarbon (liquefied petroleum gas: LPG), dimethyl ether (DME), or a fluorinated hydrocarbon (HFO-1234ZE), and a compressed gas such as carbon dioxide (CO₂), nitrogen (N₂), or nitrous oxide (N₂O) can be applied. However, in consideration of safety against fire, a non-flammable fluorinated hydrocarbon, carbon dioxide, nitrogen, nitrous oxide, and the like are suitable, and in particular, nitrogen is suitable in consideration of environmental loads.

### [Configuration of Sleeve 20]

The sleeve 20 is made of metal such as aluminum, plastic, or a lightweight material having high strength such as carbon fibers. In addition, not only hard materials but also soft materials, for example, rubber materials such as silicone rubber and urethane foam can be used. In short, various materials capable of holding the shape of the housing unit that houses the aerosol container 10 can be used. The term “sleeve” is used to mean a tubular housing member in which the cylindrical aerosol container 10 is housed.

The sleeve 20 includes a sleeve main body 21 having a cylindrical shape with a diameter larger than that of the aerosol container 10, the first end cover part 22 covering one end of the sleeve main body 21, and a second end cover part 23 provided at the other end.

The first end cover part 22 is detachably screwed and fixed to the sleeve main body 21 via a screw part, and the second end cover part 23 is undetachably fixed to the sleeve main body 21. The second end cover part 23 and the sleeve main body 21 may be integrally formed.

The first end cover part 22 includes a dome-shaped cover main body 222 and a screw cylinder 223 that is screwed into a female screw portion of the sleeve main body 21. The cover main body 222 has a conical shape with a rounded tip or a dome-shaped curved surface whose diameter is gradually reduced toward the tip end in consideration of aerodynamic characteristics. With such a shape having good aerodynamic characteristics, an impact of wind (crosswind) in the horizontal direction is reduced, and stable flight can be achieved.

The second end cover part 23 located on the bottom portion side of the aerosol container 10 includes a cylindrical part 231 that has one end fixed to the rear end portion of the sleeve main body 21 (the end portion on the bottom portion side of the aerosol container 10) and an end plate 232 that closes the other end of the cylindrical part 231. The discharge driving unit 30 is housed in this second end cover part 23.

### [Support Structure of Aerosol Container 10]

The inner diameter of the sleeve 20 is larger than the outer diameter of a body portion 11a of the container main body 11 of the aerosol container 10, and the aerosol container 10 is separated from the wall surface of the sleeve 20 to be supported at a certain distance.

The body portion 11a of the aerosol container 10 may be supported without being separated from the inside wall of the sleeve 20. However, by separating the body portion 11a of the aerosol container 10 from the inside wall of the sleeve 20, heat insulating material or heat storage material can be interposed in the separation space.

The sleeve 20 may have a structure in which a part of the structure is ventilated, instead of having a sealed structure. For example, a structure such as a mesh structure or punching can be applied. Such a structure has advantageous effects of, for example, mitigating self-cooling at the time of aerosol discharge by the outside air and reducing the weight of the sleeve 20.

A bottom portion 11b of the aerosol container 10 is supported by a container holding part 33, and the top portion side of the aerosol container 10 is supported by the pressing member 221 provided in the first end cover part 22.

The pressing member 221 includes a cylindrical body 221a protruding from the top portion of the first end cover part 22 toward the stem 12 in the direction of the centerline of the aerosol container 10 and an end flange portion 221b provided at one end of the cylindrical body 221a and fixed to the first end cover part 22. The actuator main body portion 14a is inserted into the inner periphery of the cylindrical body 221a of the pressing member 221 in a manner slidable to the axial direction, and the end surface of the cylindrical body 221a abuts against or is positioned close to the flange portion 14b of the actuator 14. The pressing member 221 may be integrally formed with the second end cover part 23.

Next, the discharge driving unit 30 will be described.

The discharge driving unit 30 includes a motor 31 serving as a rotary drive source and a cam mechanism 32 that converts rotational motion of the motor 31 into linear motion of the container holding part 33. The motor 31 and the cam mechanism 32 are assembled to a frame (not illustrated) fixed to the second end cover part 23. The cam mechanism 32 has a cam 32a that is rotationally driven by the motor 31 and a cam follower 32b that is provided on the container holding part 33. The cam follower 32b has slide contact with the cam surface of the cam 32a and moves linearly in a direction parallel to the container centerline N. The cam 32a in the illustrated example is an egg-shaped disk cam. A cam shaft is perpendicular to the container centerline N, and the rotation of the cam 32a is converted into linear motion of the container holding part 33 via the cam follower 32b. Since the cam 32a is a disk cam, pressing means such as a spring for maintaining the cam follower 32b in constant contact with the cam 32a is appropriately provided.

The container holding part 33 includes a circular disk portion 33a abutting against the bottom portion 11b of the aerosol container 10, an annular convex portion 33b that holds the end portion on the bottom portion side of the body portion 11a of the aerosol container 10 by the outer-diameter end portion of the circular disk portion 33a, and a connecting shaft portion 33c provided at the center portion of the motor-side surface of the circular disk portion 33a, and the cam follower 32b is provided on the connecting shaft portion 33c.

Normally, the minimum-diameter portion of the cam 32a abuts against the cam follower 32b, and the container holding part 33 is at a retreat limit position so that a valve mechanism of the aerosol container 10 is held in a valve-closed state. When the cam 32a is rotated by the motor 31, the container holding part 33 moves forward in the axial direction. That is, when the cam 32a abuts against the cam follower 32b at the retreat limit position, the contact position on the cam 32a is set to have a small radius from the rotation center, and when the cam 32a abuts against the cam follower 32b at the forward limit position, the contact position on the cam 32a is set to have a large radius from the rotation center.

The aerosol container 10 is moved to the top portion side in the axial direction by the container holding part 33 moving forward, and the actuator 14 is pressed against the cylindrical body 221a of the pressing member 221 by this move of the aerosol container 10. Since the pressing member 221 is fixed to the first end cover part 22 of the sleeve 20, the reaction force from the cylindrical body 221a pushes the stem 12 into the aerosol container 10 so that the valve mechanism in the aerosol container 10 is opened. When the valve mechanism is opened, the contents are automatically discharged by gas pressure.

In this example, the cam mechanism 32 converts the rotational motion of the motor 31 into the linear motion. However, the present invention is not limited to the cam mechanism 32. For example, any mechanism that converts the rotational motion of the motor 31 into the linear motion, such as a screw feed mechanism or a rack-and-pinion, is applicable. Alternatively, the aerosol container 10 can be moved in the axial direction by using, instead of using the rotary motor, a linear driving source such as a linear motor for linear driving or an electromagnetic solenoid, without using a motion conversion mechanism.

### [Configuration of Valve Mechanism]

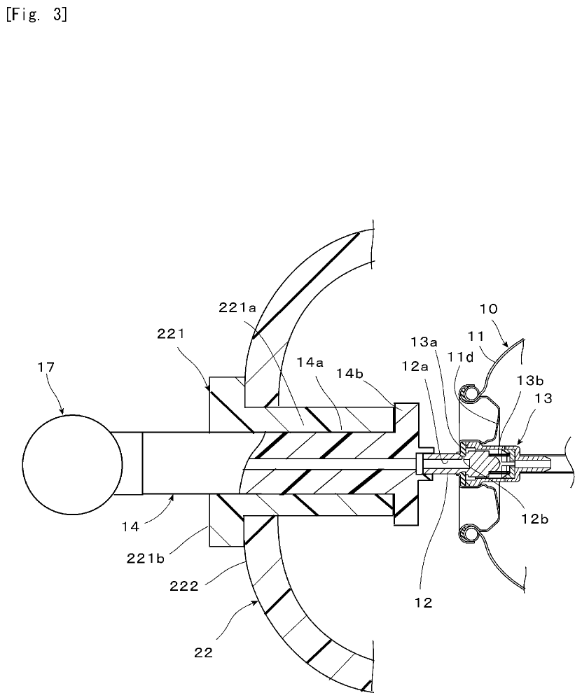

FIG. 3 illustrates an example of a valve mechanism 13 of the aerosol container 10. This valve mechanism 13 is opened by the above discharge driving unit 30.

That is, the stem 12 is provided with a discharge passage 12a extending in the axial direction by a predetermined length from a tip opening, and a stem hole 12b serving as a valve hole is opened on a side surface of the stem 12. This stem hole 12b is sealed by an inner peripheral surface of a gasket 13a attached to a hole edge of an insertion hole of a mounting cup 11d.

The stem 12 is normally pressed in a protruding direction by gas pressure and a pressing force of a spring 13b and presses an inner peripheral edge of the gasket 13a serving as a valve body in the axial direction so that an inner peripheral surface of the gasket 13a is brought into close contact with the hole edge of the stem hole 12b constituting a valve seat, thereby maintaining a valve-closed state.

When the container holding part 33 is moved to the forward limit by the cam mechanism 32 of the discharge driving unit 30 illustrated in FIG. 2, the aerosol container 10 is moved toward the first end cover part 22 side, and the flange portion 14b of the actuator 14 comes into contact with the end surface of the pressing member 221. The reaction force thereby generated pushes the stem 12 relatively toward the inside of the container. When the stem 12 is pushed in, the inner peripheral edge of the gasket 13a is bent toward the inside of the container, and the inner peripheral surface of the gasket 13a is separated from the hole edge of the stem hole 12b, thereby opening the valve. Thus, the contents pushed by the gas pressure is discharged through the discharge passage 12a of the stem 12.

The valve mechanism 13 in the illustrated example is merely an example, and the valve mechanism is not limited to this configuration. Various configurations in which the valve is normally maintained in the valve-closed state and is opened when the stem 12 is pushed in can be applied.

### [Other Methods of Discharge Driving Unit]

Next, other methods of the discharge driving unit will be described.

While the aerosol container 10 is moved inside the sleeve 20 in FIG. 2, a configuration in which the aerosol container 10 is fixed and the actuator 14 is pushed in may be applied. Alternatively, instead of having a configuration in which the aerosol container is mechanically moved, the valve mechanism of the aerosol container 10 may be constantly open, and an external valve may be used to switch discharging and stopping.

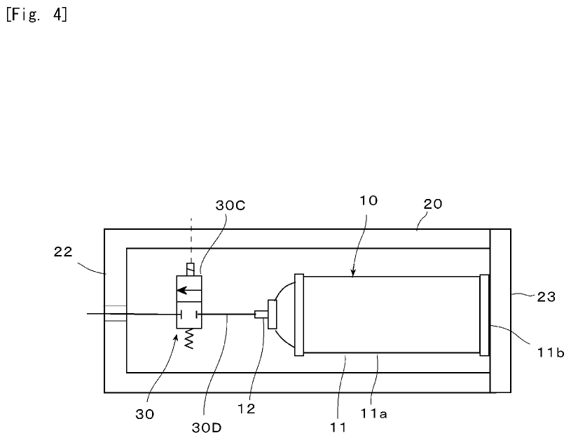

FIG. 4 illustrates a configuration in which the discharge driving unit 30 is driven by an external valve 30C, instead of the valve mechanism 13 inside the aerosol container 10. As illustrated in FIG. 4, a two-way switching valve for switching between a stop position and a discharge position by a solenoid can be used as the external valve 30C. Normally, the valve is held at the stop position, and at the time of discharging, the valve is switched to the discharge position by driving the solenoid to discharge the contents. In a case of using such an external valve 30C, the aerosol container 10 is easily attached only by connecting the stem 12 of the aerosol container 10 to a duct 30D, and also opening and closing is easily controlled. In a case of using an existing aerosol container 10, for example, the stem 12 is pushed in at the time of assembling the aerosol container 10 so as to hold the internal valve in a constantly opened state.

### [Electric Installation]

Next, returning to FIG. 1(A), an electric installation for driving the discharge driving unit 30 and the motor 18 of the nozzle 15 will be described. FIG. 1(A) conceptually illustrates an electric installation mounted on the air vehicle.

A mounted device control unit 210 for controlling the mounted devices such as the discharge driving unit 30 and the motor 18 of the nozzle 15 is provided separately from a flight control unit 110 for controlling the flight of the air vehicle 100 and is disposed on the airframe 101 side together with the flight control unit 110. Further, a mounted device power supply 211 for driving the discharge driving unit 30 and the motor 18 for rotating the nozzle 15 is provided separately from a power supply (which is incorporated in the flight control unit 110 and is not illustrated) for driving the air vehicle 100 and is mounted on the airframe 101 side. The motor 18 and the mounted device power supply 211 constitute driving means for the nozzle 15 of the present invention. The mounted device control unit 210 is provided with a control system for the motor 18 of the nozzle 15, as well as for the discharge driving unit 30, so as to adjust the angle of the nozzle 15. In addition, a mounted device communication unit 212 that includes an antenna for remotely controlling the discharge apparatus 1 and the nozzle 15 is provided separately from a flight communication unit 112 that includes an antenna for remotely controlling the air vehicle 100 and is mounted on the airframe 101.

A part or all of the flight control unit 110, the flight communication unit 112, and the flight power supply may serve as the mounted device control unit 210, the mounted device communication unit 212, and the mounted device power supply 211.

[Support Structure with Respect to Airframe]

The connecting part 50 that connects the aerosol container assembly 40 to the airframe 101 may have, for example, a slide-type fitting structure using a slide rail and a T-shaped groove, or a structure attachable and detachable in a rotation direction such as bayonet coupling. Further, various support means that facilitate attachment and detachment, such as screwing, clip coupling, and clamping, can also be applied.

Electrical contacts may be provided to electrically connect between the mounted device control unit 210 and the mounted device power supply 211 disposed on the airframe 101 side and the motor 31 of the discharge driving unit 30, the motor 18 for driving the nozzle 15, and the like, or these components may be directly connected to connectors disposed from the sleeve 20 to the airframe 101 with cables or the like. In addition, a power supply such as a secondary battery and a radio communication device may be provided in the sleeve 20, and electric signals from the flight control unit 110 disposed on the airframe 101 side may be transmitted to and received from the mounted device control unit 210 in the sleeve 20 by radio communication.

Next, operations of the discharge apparatus for the air vehicle according to the present invention will be described.

### [Replacement Operation]

A replacement aerosol container assembly 40 in which a new aerosol container 10 is housed in a sleeve 20 as illustrated in FIG. 2 is prepared in advance. In the replacement operation, the used aerosol container assembly 40 is detached from the airframe body 102, and the new aerosol container assembly 40 is attached thereto. The aerosol container 10 is removed from the sleeve 20 of the used aerosol container assembly 40, and the gas and contents in the removed aerosol container 10 are completely released to be discarded. The sleeve 20 can be repeatedly used. Alternatively, in this embodiment, only the aerosol container 10 can be replaced while the sleeve 20 is fixed to the airframe 101.

### [Spraying Operation]

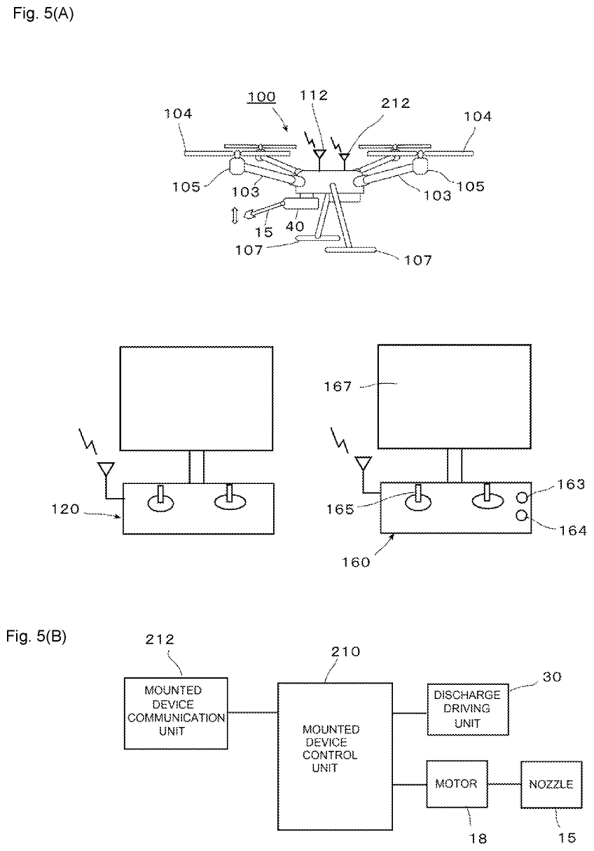

Next, a spraying operation will be described with reference to FIG. 5. FIG. 5(A) is an explanatory diagram illustrating an example of a maneuvering terminal and an operating terminal conducting remote-control operations of the air vehicle on which the discharge apparatus is mounted, and FIG. 5(B) is a simple control block diagram.

For example, as illustrated in FIG. 5(A), in the spraying operation, the flight of the air vehicle 100 is remotely controlled by a maneuvering terminal 120, and the discharge apparatus 1 is remotely controlled by an operating terminal 160. The operating terminal 160 is provided with, for example, an operation lever 165 for the nozzle 15, a discharge button 163, and a stop button 164, and the operator adjusts the discharge direction of the nozzle 15 while watching the image on a display 167.

When the operator operates the operation lever 165, a direction change command signal is transmitted and received by the mounted device communication unit 212 mounted on the air vehicle 100. Based on the received direction change command signal, the mounted device control unit 210 performs arithmetic processing to obtain an angle of the nozzle 15, a drive signal is transmitted to the motor 18, and the motor 18 is thereby driven so that the nozzle 15 is driven to rotate to a designated angle and stopped.

When the orientation of the nozzle 15 is determined, the operator presses the discharge button 163 so that a discharge command signal is transmitted.

The discharge command signal is received by the mounted device communication unit 212 mounted on the air vehicle 100, and based on the received discharge command signal, the mounted device control unit 210 drives the discharge driving unit 30. The stem 12 of the aerosol container 10 is thereby pushed in, and the contents are discharged. When the operator presses the stop button 164, a stop command signal is transmitted, and the pushed-in state of the stem 12 is thereby released by the discharge driving unit 30 so that the discharge is stopped.

Switching between discharging and stopping may be performed not only by the operation of the button but also by automatic switching in accordance with a pre-stored program. For example, a flight route can be pre-programmed. The location of the air vehicle 100 may be detected on a map based on a signal from a GPS, and the altitude may be detected by an altimeter. The discharge apparatus 1 can be configured to start discharging when the air vehicle 100 reaches a predetermined location and stop discharging when the discharging in a predetermined area is completed.

In the above embodiment, the nozzle 15 is stopped at a predetermined angle to be used. However, instead of such a use, the nozzle 15 may be continuously rotated and discharge the contents while changing the angle.

Further, the nozzle 15 may be configured without a motor to drive. Instead, the nozzle 15 may be made rotatable, and the angle of the nozzle may be manually adjusted. That is, the nozzle 15 may be adjusted to have a predetermined angle before flight and may be configured to be non-adjustable during flight. In this case, as means for holding the angle of the nozzle, for example, a first joint member and a second joint member of a swivel pipe joint can be brought into sliding friction contact and set to be rotatable but held at a predetermined angle by a moderate friction force. Other various angle holding mechanisms, such as a ratchet mechanism, can also be used.

Next, other embodiments of a discharge apparatus for an air vehicle according to the present invention will be described. In the following description, only portions different from the above embodiment will be described. The same components will be denoted by the same reference numerals, and description thereof will be omitted.

### Embodiment 2

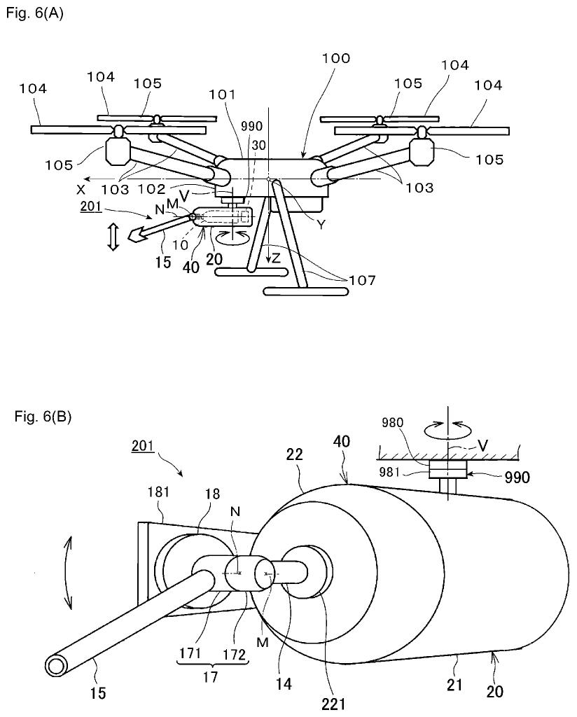

Next, Embodiment 2 of the present invention will be described with reference to FIG. 6.

FIG. 6(A) is a perspective view illustrating an overall configuration of an air vehicle, and FIG. 6(B) is a perspective view of a discharge apparatus viewed diagonally from the front.

In a discharge apparatus 201 of Embodiment 2, the aerosol container 10 mounted on the exterior of the airframe 101 is supported with respect to the airframe 101 so as to be rotatable around a turning axis V parallel to the yaw axis Z, and the turning axis V and the rotation axis M of the nozzle 15 are separated from each other by a predetermined distance.

Specifically, Embodiment 2 is similar to Embodiment 1 in that the nozzle 15 is supported so as to be vertically rotatable around a horizontal rotation axis M (parallel to the pitch axis) via the swivel pipe joint 17 having a degree of rotational freedom of a single axis, whereas Embodiment 2 differs from Embodiment 1 in that the aerosol container assembly 40 is rotatably supported with respect to the airframe 101 via a rotary support unit 990. That is, the aerosol container assembly 40 mounted on the airframe 101 is supported with respect to the airframe body 102 so as to be horizontally rotatable around the turning axis V parallel to the yaw axis Z in a horizontally loaded configuration such that the container centerline N is parallel to the roll axis X of the airframe 101.

The rotary support unit 990, which is conceptually illustrated, includes a motor 980 as container driving means fixed to the airframe 101 side and a support member 981 and has a configuration in which the aerosol container assembly 40 and the motor 980 are connected via the support member 981.

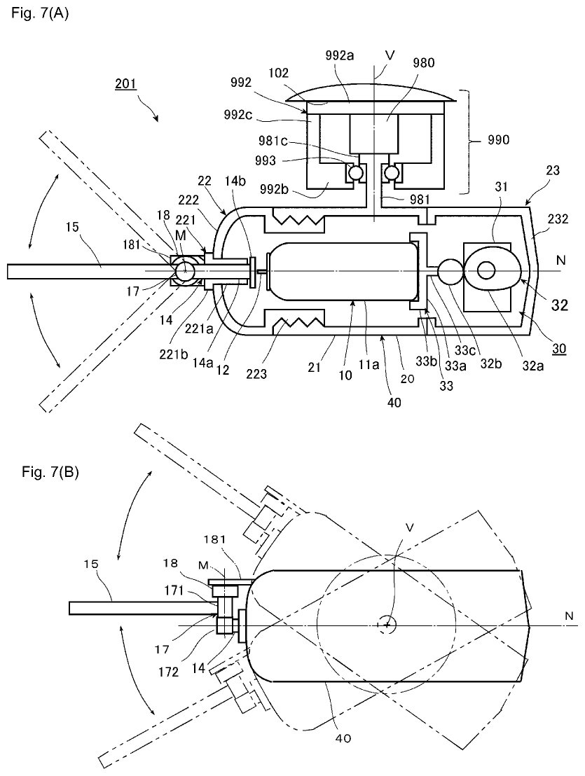

FIG. 7(A) illustrates a specific configuration example of the rotary support unit 990.

The motor 980 is housed in a support box 992 fixed to the airframe body 102, and the upper end of the support member 981 is rotatably supported by the support box 992 via a rotary bearing 993 and connected to the motor 980.

The support box 992 has a base plate part 992a, an end plate part 992b arranged below the base plate part 992a with predetermined spacing and facing each other, and a side plate part 992c connecting the base plate part 992a and the end plate part 992b, and the upper end of the support member 981 is rotatably supported by the end plate part 992b via the rotary bearing 993. The upper end of the support member 981 is provided with a flange 981c engaged with the rotary bearing 993. The support member 981 extends vertically downward along the turning axis V, and the lower end of the support member 981 is fixed to the sleeve 20 of the aerosol container assembly 40.

As illustrated in FIG. 7(B), the discharge apparatus of Embodiment 2 is configured such that the aerosol container assembly 40 horizontally rotates around the turning axis V with respect to the airframe so as to set the azimuth angle of the nozzle 15 to a target angle, and at this orientation, the nozzle 15 rotates around the rotation axis M to be directed at a target and adjust the predetermined elevation angle or depression angle. In this way, the nozzle 15 can be directed to a discharge target regardless of the orientation of the air vehicle 100.

As described above, while the nozzle 15 is configured to vertically rotate around the single rotation axis M, the nozzle 15 can be turned by rotating the aerosol container assembly 40 around the turning axis V so that the azimuth angle of the nozzle 15 is adjustable. As a result, the discharge range can be widened.

### Embodiment 3

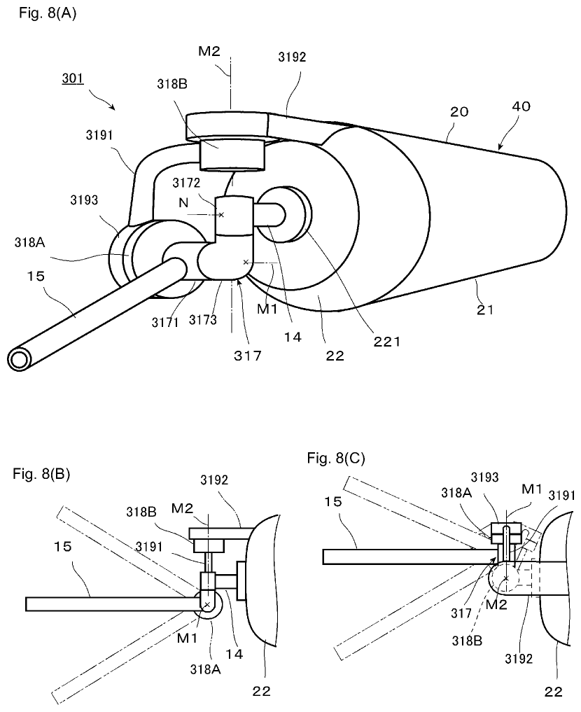

Next, Embodiment 3 of the present invention will be described with reference to FIG. 8.

FIG. 8 illustrates a discharge apparatus for an air vehicle according to Embodiment 3 of the present invention. FIG. 8(A) is a perspective view of a sleeve viewed diagonally from the front, FIG. 8(B) is a side view illustrating the vicinity of a nozzle attachment portion, and FIG. 8(C) is a top view illustrating the vicinity of the nozzle attachment portion.

In a discharge apparatus 301 of Embodiment 3, the nozzle 15 has two rotation axes having different directions from each other, and the nozzle 15 is rotatable in two directions. In the illustrated example, the rotation axes are set in two directions, which are a first rotation axis M1 in the horizontal direction and a second rotation axis M2 in the vertical direction, and the nozzle 15 is configured to rotate up and down and from side to side.

Specifically, the nozzle 15 is rotatable in two directions with respect to the actuator 14 of the aerosol container 10 via a two-way swivel pipe joint 317 having the first rotation axis M1 and the second rotation axis M2 that are perpendicular to each other.

The aerosol container 10 is arranged such that the container centerline N is parallel to the roll axis X of the airframe 101. The first rotation axis M1 is arranged to be parallel to the pitch axis Y, and the second rotation axis M2 is arranged to be parallel to the yaw axis Z of the airframe 101. Thus, the nozzle 15 is vertically rotatable around the first rotation axis M1 to be able to adjust the elevation and depression angle and is horizontally rotatable from side to side around the vertical second rotation axis M2 to be able to adjust the azimuth angle.

The two-way swivel pipe joint 317 includes a joint body part 3173, a first joint member 3171 rotatably assembled to the joint body part 3173 along the first rotation axis M1, and a second joint member 3172 rotatably connected to the joint body part 3173 along the second rotation axis M2.

The actuator 14 protruding from the first end cover part 22 of the sleeve 20 is connected to the second joint member 3172. The actuator 14 extends along the container centerline N and is connected to the second joint member 3172 in a direction perpendicular to the axis. The joint body part 3173 is connected to this second joint member 3172 so as to be horizontally rotatable around the second rotation axis M2 extending in the vertical direction. The first joint member 3171 is connected to the joint body part 3173 so as to be rotatable around the horizontal first rotation axis M1. The nozzle 15 is connected in a direction perpendicular to the first rotation axis M1 as in Embodiment 1.

Thus, the nozzle 15 can rotate up and down around the first rotation axis M1 so that the elevation angle and the depression angle can be adjusted, and the nozzle 15 can also rotate from side to side around the second rotation axis M2 so that the azimuth angle can be adjusted. The contents to be discharged from the actuator 14 flow into the nozzle 15 through the flow passages inside the second joint member 3172, the joint body part 3173, and the first joint member 3171 and are discharged from the tip of the nozzle 15.

In the present embodiment, a first motor 318A for driving the nozzle 15 to rotate around the first rotation axis M1 and a second motor 3186 for driving the nozzle 15 to rotate around the second rotation axis M2 are provided. While being illustrated in a simplified manner, the first motor 318A and the second motor 318B may be provided with a transmission mechanism such as gears or may be provided with a clutch mechanism. That is, various configurations may be adopted.

As in Embodiment 1, the first motor 318A is operatively connected to the first joint member 3171 and rotationally drives the first joint member 3171 to adjust the vertical angle of the nozzle 15. In contrast, the second motor 318B is disposed immediately above and apart from the second joint member 3172, and a rotation axis of the second motor 318B is arranged to be aligned with an extension line of the second rotation axis M2. The second motor 318B is supported by the sleeve 20 via a second support frame 3192 and is connected to a motor support part 3193 of the first motor 318A via a first support frame 3191.

Thus, the second motor 318B drives the entire two-way swivel pipe joint 317 including the nozzle 15 to rotate around the second rotation axis M2 via the first support frame 3191 and the first motor 318A. The first motor 318A is supported by the sleeve 20 via the first support frame 3191, the second motor 3186, and the second support frame 3192.

The support configuration of the first motor 318A and the second motor 318B is not limited to the above configuration. For example, the second motor 318B may be directly connected to the second joint member 3172, and one end of the first support frame 3191 supporting the first motor 318A may be fixed to the sleeve 20.

Also, in Embodiment 3, the first motor 318A and the second motor 318B receive power from the mounted device power supply 211 as illustrated in FIG. 1(A) and can be operated by the operating terminal 160. The first motor 318A and the mounted device power supply 211 constitute driving means for driving the nozzle 15 to rotate around the first rotation axis M1, and the second motor 318B and the mounted device power supply 211 constitute driving means for driving the nozzle 15 around the second rotation axis M2. Further, a control system may be added to the mounted device control unit 210 to control the angle of the nozzle 15 as well as the discharge driving unit 30.

In the spraying operation, when the operator operates the above-described operation lever 165 illustrated in FIG. 5, a direction change command signal is transmitted. In response, the mounted device control unit 210 performs arithmetic processing to obtain respective angles of the nozzle 15 around the first rotation axis M1 and the second rotation axis M2, and corresponding control signals are transmitted to the first motor 318A and the second motor 318B so that the first motor 318A and the second motor 318B are each driven to control the angle of the nozzle 15.

In this way, in addition to the elevation angle and the depression angle, the azimuth angle of the nozzle 15 can also be adjusted. As a result, the discharge range can be widened.

In this embodiment, the second rotation axis M2 is to be parallel to the yaw axis Z of the airframe, and the first rotation axis M1 is set to be parallel to the pitch axis Y of the airframe. However, the first rotation axis M1 and the second rotation axis M2 may be inclined at a predetermined angle with respect to the pitch axis Y and the yaw axis Z, respectively, while maintaining a right angle to each other.

Further, the first rotation axis M1 and the second rotation axis M2 may not be at a right angle to each other, or the first rotation axis M1 and the second rotation axis M2 may not be perpendicular to the container centerline N.

### Embodiment 4

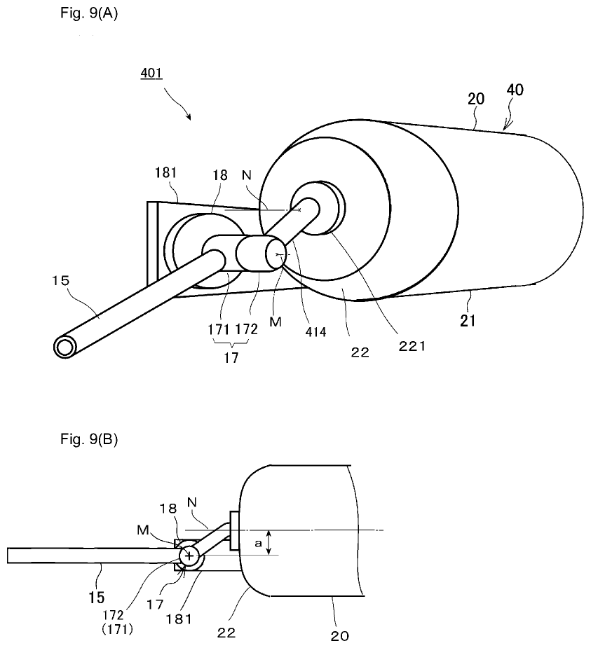

Next, Embodiment 4 of the present invention will be described with reference to FIG. 9.

FIG. 9(A) is a perspective view of a discharge apparatus for an air vehicle according to Embodiment 4 of the present invention when viewed diagonally from the front, and FIG. 9(B) is a side view illustrating the vicinity of a nozzle.

A discharge apparatus 401 of Embodiment 4 is similar to the discharge apparatus of Embodiment 1 in that the nozzle 15 is supported so as to be vertically rotatable around the horizontal rotation axis M via the swivel pipe joint 17 having a degree of rotational freedom of a single axis, whereas the discharge apparatus 401 differs from the discharge apparatus of Embodiment 1 in that the position of the rotation axis M is offset with respect to the container centerline N by a predetermined distance.

That is, in Embodiment 4, the rotation axis M is located lower than the extension line of the container centerline N by a predetermined distance, and the actuator 14 connected to the second joint member 172 of the swivel pipe joint 17 is inclined and extended downward with respect to the extension line of the container centerline N. That is, the actuator 14 is positioned on the container centerline N at the portion fitted into the pressing member 221 of the first end cover part 22 of the sleeve 20 and then is linearly inclined downward to be gradually away from the container centerline N toward the front, and the tip of the actuator 14 is connected to the second joint member 172.

By having such an offset structure, the contents can be discharged in a range away from the container centerline. For example, in a case where the airframe 101 and the nozzle 15 interfere with each other, the interfering range can be reduced by having the offset structure.

In Embodiment 4, an offset amount a is assumed to be set within a range of a maximum diameter of the outer periphery of the aerosol container assembly 40.

### Embodiment 5

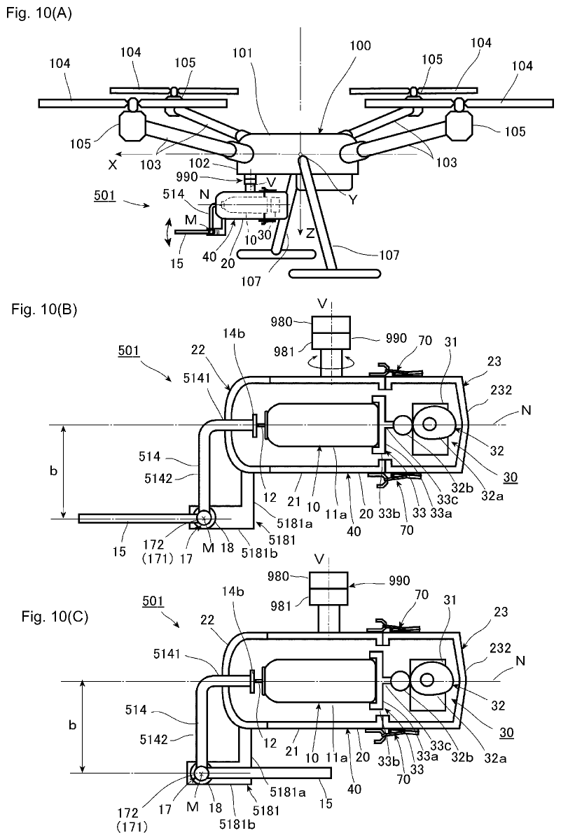

Next, Embodiment 5 of the present invention will be described with reference to FIG. 10.

FIG. 10(A) is a perspective view illustrating an overall configuration of an air vehicle, FIG. 10(B) is a cross-sectional view of a discharge apparatus, and FIG. 10(C) is a cross-sectional view of the discharge apparatus whose nozzle is directed backward.

A discharge apparatus 501 of Embodiment 5 has, as in the case with Embodiment 4, a configuration in which the rotation axis M of the nozzle 15 is largely offset in a direction perpendicular to the container centerline N of the aerosol container 10. In Embodiment 5, an offset amount b of the nozzle 15 is set to a size that allows the nozzle 15 to rotate toward the bottom portion side of the aerosol container 10 without interfering with the other parts. Specifically, the rotation axis M of the swivel pipe joint 17 is located outside a maximum-diameter portion of the aerosol container assembly 40.

Also, in this embodiment, the aerosol container assembly 40 has a horizontally loaded configuration such that the container centerline N is parallel to the roll axis X of the airframe 101, and the rotation axis M of the nozzle 15 is located lower than the extension line of the container centerline N. In the illustrated example, the rotation axis M is located further lower than the outer wall of the aerosol container assembly 40 by a predetermined distance so as to secure space for the nozzle 15 directed backward.

An actuator 514 protruding from the first end cover part 22 of the sleeve 20 is bent downward in an L-shape, and a lower end portion is connected to the first joint member 171 of the swivel pipe joint 17. That is, the actuator 514 has a first pipe portion 5141 extending horizontally and a second pipe portion 5142 extending downward at a right angle from the first pipe portion 5141, and the second pipe portion 5142 is connected to the first joint member 171 of the swivel pipe joint 17. In the illustrated example, the first joint member 171 is overlapped and hidden behind the second joint member 172. However, the configuration is the same as that in FIG. 9(A).

Since the swivel pipe joint 17 is located lower than the container centerline N, a support frame 5181 supporting the motor 18 also extends downward from the first end cover part 22 of the sleeve 20. That is, the support frame 5181 includes a first support part 5181a having a base portion fixed to the sleeve 20 and extending downward and a second support part 5181b protruding forward from a lower end portion of the first support part 5181a, and the motor 18 is supported by the second support part 5181b.

In addition, in Embodiment 5, as in Embodiment 2, the aerosol container assembly 40 is supported with respect to the airframe 101 via the rotary support unit 990 to be rotatable around the turning axis V parallel to the yaw axis Z. The rotary support unit 990 is illustrated in a simplified manner by only illustrating the motor 980 and the support member 981.

Further, in Embodiment 5, the second end cover part 23 in which the discharge driving unit 30 is housed is openable and closable with respect to the sleeve main body 21, and aerosol container 10 can be replaced by opening the second end cover part 23 in a state where the sleeve main body 21 is attached to the airframe 101.

In the illustrated example, the second end cover part 23 is detachably fixed to the sleeve main body 21 by a snap lock 70.

In the illustrated example, two snap locks 70 are provided at respective positions 180-degree opposite from each other. To open, the two snap locks 70 can be simultaneously unlocked or can be unlocked one by one. In this way, the second end cover part 23 can be separated from the sleeve main body 21.

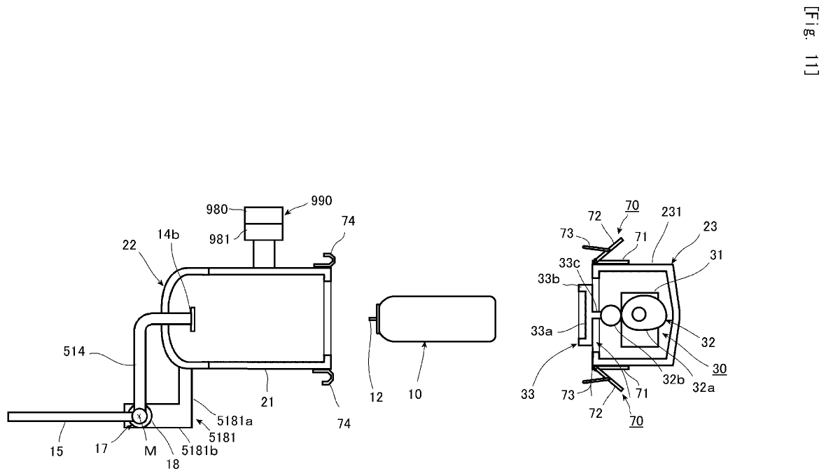

Next, the snap lock 70 will be described with reference to FIG. 11.

FIG. 11 is an exploded cross-sectional view of the aerosol assembly in FIG. 10 in a state where the snap locks 70 are unlocked.

The individual snap lock 70 includes a lock main body 71 fixed to an opening portion of the second end cover part 23 of the sleeve 20, a lever 72 rotatably attached to the lock main body 71, a snap ring 73 rotatably attached to a middle portion of the lever 72, and a hook member 74 fixed to an opening edge of the sleeve main body 21. To connect and fix the second end cover part 23, the lever 72 is raised while the first end cover part 22 is closed, and the snap ring 73 is hooked on the hook member 74. Next, by bringing the lever 72 down, the snap ring 73 hooked on the hook member 74 is pulled by the action of the lever so that the second end cover part 23 is firmly fixed by the tensile force acting on the snap ring 73. To open, by raising the lever 72, the snap ring 73 is released from the hook member 74.

In this way, the second end cover part 23 and the discharge driving unit 30 housed therein can be separated from the sleeve main body 21. Thus, the aerosol container 10 can be easily replaced. The means for fixing the second end cover part 23 to the sleeve main body 21 is not limited to the use of the snap lock 70. Other detachably fixing means such as screw engagement can be adopted.

According to the present embodiment, the aerosol container assembly 40 is rotatably supported by the rotary support unit 990 so that the azimuth angle can be adjusted, and the nozzle 15 can be quickly turned 180-degree backward only by rotating the nozzle 15 while the aerosol container assembly 40 is directed forward.

### Embodiment 6

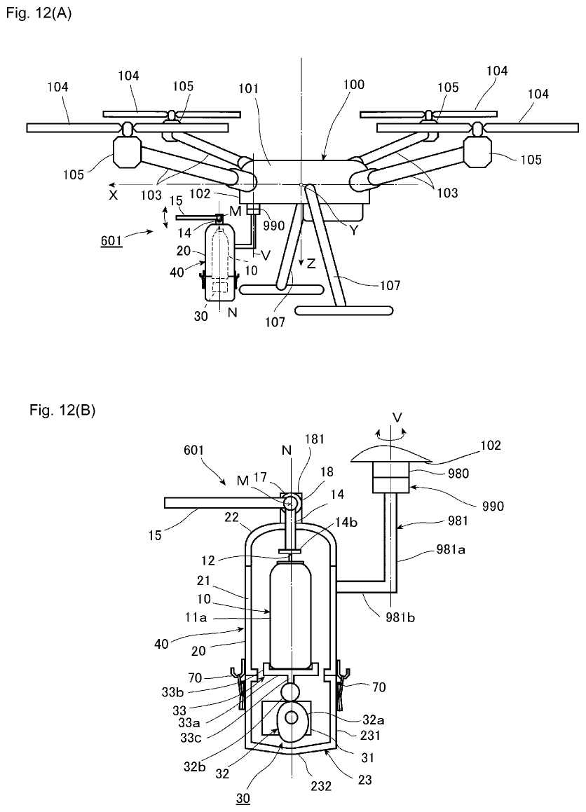

Next, Embodiment 6 of the present invention will be described with reference to FIG. 12.

FIG. 12 conceptually illustrates a discharge apparatus for an air vehicle according to Embodiment 6 of the present invention. FIG. 12(A) is a perspective view illustrating an overall configuration of the air vehicle, and FIG. 12(B) is a cross-sectional view of the discharge apparatus.

A discharge apparatus 601 of Embodiment 6 is similar to the discharge apparatus of Embodiment 1 in that the nozzle 15 is supported with respect to the actuator 14 of the aerosol container 10 so as to be vertically rotatable around the horizontal rotation axis M (parallel to the pitch axis) via the swivel pipe joint 17 having a degree of rotational freedom of a single axis, whereas the discharge apparatus 601 differs from the discharge apparatus of Embodiment 1 in that the aerosol container assembly 40 mounted on the airframe 101 is in a vertically loaded configuration such that the container centerline N is parallel to the yaw axis Z of the airframe 101.

In the illustrated example, the aerosol container is mounted with its top portion pointed upward and its bottom portion pointed downward, and the actuator 14, the swivel pipe joint 17, and the nozzle 15 are provided at the upper end portion of the aerosol container assembly.

Embodiment 6 also differs from Embodiment 1 in that, as in Embodiment 5, the aerosol container assembly 40 is supported with respect to the airframe 101 to be rotatable in the horizontal direction around the turning axis V parallel to the yaw axis Z. The aerosol container assembly 40 is rotatably supported by the rotary support unit 990 of the airframe body 102 via the support member 981.

The support member 981 is an L-shaped member including a vertical first support portion 981a and a horizontal second support portion 981b. The first support portion 981a linearly extends along the turning axis V, and the second support portion 981b extends at a right angle from the lower end of the first support portion 981a and is fixed to the aerosol container assembly 40.

The first support portion 981a constituting the turning axis V is located at a front end portion of the airframe body 102, and the aerosol container assembly 40 is turnable around the turning axis V on a circular track while maintaining the attitude such that the container centerline N is parallel to the yaw axis Z.

Thus, the azimuth angle of the nozzle 15 can be adjusted by turning the aerosol container assembly 40 around the turning axis V, and the elevation angle and the depression angle of the nozzle 15 can be adjusted by vertically moving the nozzle 15.

The rotation axis M of the nozzle 15 is not limited to the horizontal direction as in the horizontally laid configuration in Embodiment 1 and may be set to the vertical direction to allow the nozzle 15 to be rotatable from side to side. If the nozzle 15 is configured to be rotatable in the horizontal direction, for example, the azimuth angle can be coarsely adjusted by turning the aerosol container assembly 40 and can be finely adjusted by rotating the nozzle 15 around the rotation axis. In addition, the direction of the rotation axis is not limited to the vertical and horizontal direction but may be inclined at a predetermined angle with respect to the horizontal or vertical direction.

Next, effects of the present embodiment will be described.

In the case where the aerosol container 10 is horizontally loaded as in Embodiment 1 or Embodiment 2, a separation-type aerosol container is used. In this case, as the amount of contents decreases, the space occupied by the contents moves sideways, thereby moving the position of the center of gravity sideways. As a result, the stability of the airframe is disturbed. In contrast, in the case where the aerosol container 10 is vertically loaded as in the present embodiment, even when the amount of contents of the separation-type container decreases, the position of the center of gravity only moves vertically. As a result, the airframe can maintain the stability so that the discharge direction can be stabilized.

### Embodiment 7

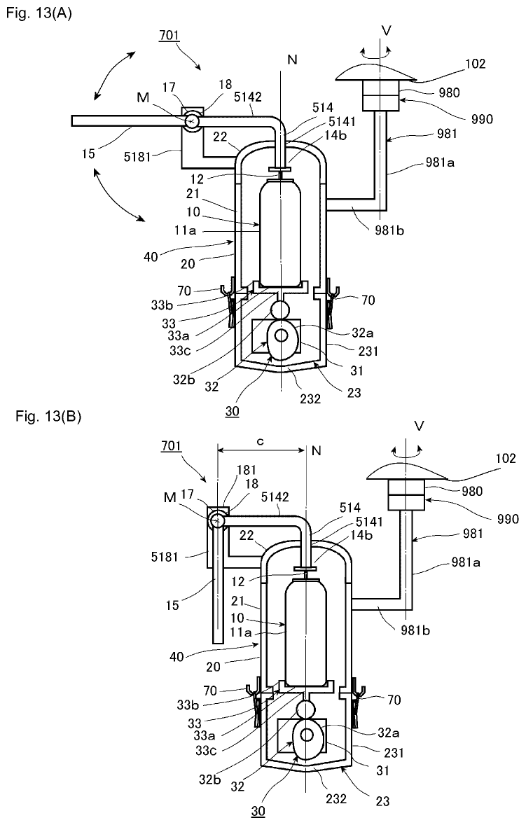

Next, Embodiment 7 of the present invention will be described with reference to FIG. 13.

FIG. 13 conceptually illustrates a discharge apparatus for an air vehicle according to Embodiment 7 of the present invention. FIG. 13(A) is a cross-sectional view illustrating a state in which a nozzle is directed forward, and FIG. 13(B) is a cross-sectional view illustrating a state in which a nozzle is directed downward.

A discharge apparatus 701 of Embodiment 7 has a basic configuration similar to that of Embodiment 6. Embodiment 7 differs from Embodiment 6 in that, as in Embodiment 5, the rotation axis M of the nozzle 15 is offset in a direction perpendicular to the container centerline N of the aerosol container 10 via an L-shape actuator 514, and an offset amount c is set to such a size that the nozzle 15 can rotate toward the bottom portion side of the aerosol container 10 without interfering with the other parts. Specifically, the rotation axis M of the swivel pipe joint 17 is located outside a maximum-diameter portion of the aerosol container assembly 40.

When the rotation axis M of the nozzle 15 is not offset from the container centerline N, the downward rotation of the nozzle 15 is limited by the interference with the first end cover part 22 of the sleeve 20. In contrast, when the rotation axis M of the nozzle 15 is offset as in Embodiment 7, the depression angle can be widened up to 90°.

While the aerosol container 10 is housed in the sleeve 20 and mounted on the airframe 101 in Embodiments 1 to 7 described above, the aerosol container 10 does not necessarily need to be mounted in the state being housed in the sleeve 20. Hereinafter, an embodiment in which the aerosol container is attached to the airframe without being stored in the sleeve will be described.

### Embodiment 8

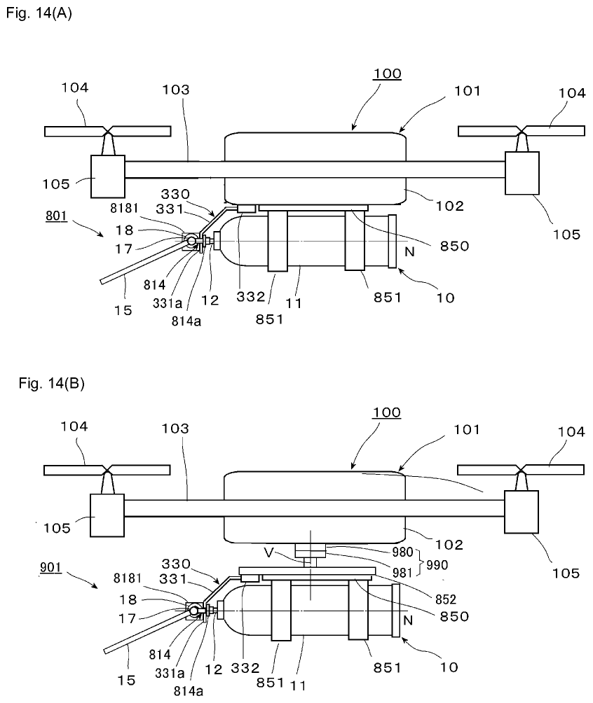

FIG. 14(A) illustrates a discharge apparatus for an air vehicle according to Embodiment 8 of the present invention. Although the air vehicle 100 is illustrated more simply in FIG. 14 than in Embodiment 1, the basic configuration is the same, and the same components will be denoted by the same reference numerals.

Also, in a discharge apparatus 801 of Embodiment 8, the aerosol container 10 is mounted on the exterior of the airframe 101, and one end of the nozzle 15 is rotatably supported with respect to an actuator 814, which is a discharge end part of the aerosol container 10, via the swivel pipe joint 17 that allows the nozzle 15 to rotate.

In Embodiment 8, a support configuration for the aerosol container 10, an attachment configuration for the nozzle 15, and a configuration of a discharge driving unit are different from those in Embodiment 1.

First, the support configuration for the aerosol container 10 will be described.

Embodiment 8 is similar to Embodiment 1 in that the aerosol container 10 is mounted in a horizontally loaded state with the horizontal container centerline N, whereas Embodiment 8 differs from Embodiment 1 in that a container supporting device 850 that supports the aerosol container 10 in an exposed state is provided on a lower surface of the airframe body 102. The container supporting device 850 includes a holding member 851 that holds the body portion of the aerosol container 10 so as to support the aerosol container 10 with respect to the airframe 101 by using the holding member 851. The support means for the aerosol container 10 is not limited to the holding member 851. Various kinds of support means may be used. For example, the aerosol container 10 may be fixed by fastening with a band, or a holding member may be screw-fixed to the aerosol container 10.

Next, the attachment structure for the nozzle 15 will be described.

An attachment portion at one end of the nozzle 15 is connected to the actuator 814 engaged with the stem 12 via the swivel pipe joint 17. The rotation axis M of the swivel pipe joint 17 is set in the horizontal direction (a pitch-axis direction) perpendicular to the container centerline N. The configuration of the swivel pipe joint 17 is the same as that in Embodiment 1.

A discharge driving unit 330 includes a pushing member 331 provided with an engaging part 331a that engages with a flange part 814a of the actuator 814 and a driving part 332, which is driving means such as a solenoid or a linear motor, for linearly driving the pushing member 331. The driving part 332 drives the pushing member 331 in the axial direction of the aerosol container, thereby driving the stem 12 in a direction to be pushed into the container via the pushing member 331 and the actuator 14. The driving part 332 may have any mechanism for driving in the linear direction. For example, the driving part 332 may be configured to linearly drive directly by using a linear motor, a solenoid, or the like or via a motion conversion mechanism, such as a cam or a screw feeding mechanism, that converts a rotary motion of a rotary motor into a linear motion.

The motor 18 is attached to the engaging part 331a of the pushing member 331 in the discharge driving unit 330 via a support member 8181, and the swivel pipe joint 17 is rotationally driven by the motor 18 so that the nozzle 15 rotates up and down to adjust the elevation angle and the depression angle. The swivel pipe joint 17 has a similar configuration to that in Embodiment 1.

Next, Embodiment 9 of the present invention will be described.

FIG. 14(B) illustrates a discharge apparatus for an air vehicle according to Embodiment 9 of the present invention.

A discharge apparatus 901 of Embodiment 9 has a basic configuration similar to that of Embodiment 8. Embodiment 9 differs from Embodiment 8 in that the aerosol container 10 is supported with respect to the airframe 101 via the rotary support unit 990 to be rotatable around the vertical turning axis V.

Although the rotary support unit 990 is illustrated in a simplified manner, the rotary support unit 990 has a configuration basically similar to that of Embodiment 2 and has the motor 980 and the support member 981 that is rotationally driven by the motor 980. One end of the support member 981 is operatively connected to the motor 980, and the other end of the support member 981 is fixed to a connection plate 852. The container supporting device 850 and the discharge driving unit 330 including the pushing member 331 described in Embodiment 8 are arranged on the connection plate 852.

As described above, while the nozzle 15 is configured to be vertically rotated around the single rotation axis M, by horizontally rotating the aerosol container 10 around the turning axis V, the azimuth angle of the nozzle 15 can be adjusted. As a result, the discharge range can be widened.

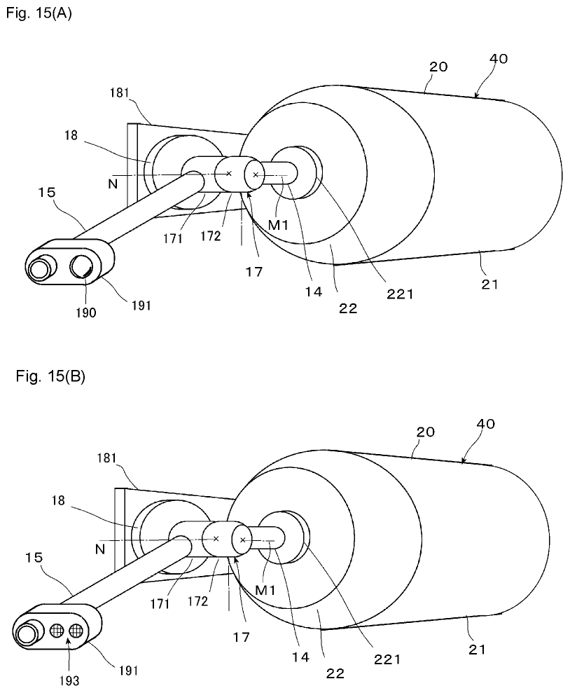

Next, additional structures such as a camera and a distance sensor that are applicable to the above-described Embodiments 1 to 9 will be described with reference to FIG. 15.

FIG. 15(A) illustrates a structure in which a camera 190 is added to a tip portion of the nozzle 15 via a holding member 191, and FIG. 15(B) illustrates a structure in which a distance sensor 193 is added to a tip portion of the nozzle 15 via a holding member 191. While the nozzle 15 of the discharge apparatus of Embodiment 1 is illustrated as an example in FIG. 15, the camera 190 or the distance sensor 193 can also be added to the nozzle 15 of the discharge apparatus in each of Embodiments 2 to 9.

By attaching the camera 190 to the nozzle 15 as illustrated, when the direction of the nozzle 15 is changed, the camera 190 moves synchronously with the nozzle 15 and follows the discharge direction of the nozzle 15 so that a discharge state can be visually recognized in a visual field range of the camera 190 at all times.

By disposing the distance sensor 193 on the nozzle 15, a distance to a discharge target can be measured so that whether the discharge target is within discharging distance can be detected. As a result, the contents can be sprayed onto the discharge target without fail, and wasted consumption of the contents can be reduced.

In each embodiment described above, the multicopter has been used as an example of the air vehicle on which the discharge apparatus is mounted. However, the discharge apparatus for a moving vehicle according to the present invention can also be applied to a helicopter. Further, this discharge apparatus can be applied not only to an air vehicle with rotors but also to a fixed-wing aircraft, an airship, and an unmanned aircraft such as a gliding aircraft and can be applied not only to an unmanned aircraft but also to a manned aircraft.

### REFERENCE SIGNS LIST

Embodiment 1 (FIGS. 1 to 5)
1 Discharge apparatus
10 Aerosol container
11a Body portion
11b Bottom portion
11d Mounting cup
12 Stem
12a Discharge passage
12b Stem hole
13 Valve mechanism
13a Gasket
13b Spring
14 Actuator
14a Actuator main body portion
14b Flange portion
15 Nozzle
17 Swivel pipe joint
171 First joint member
172 Second joint member
18 Motor
181 Support member
20 Sleeve (Housing member)
21 Sleeve main body
22 First end cover part
221 Pressing member
221a Cylindrical body
221b End flange portion
222 Cover main body
223 Screw cylinder
23 Second end cover part
231 Cylindrical part
232 End plate
30 Discharge driving unit
31 Motor
32 Cam mechanism
32a Cam
32b Cam follower
33 Container holding part
33a Circular disk portion
33b Annular convex portion
33c Connecting shaft portion
30C External valve
30D Duct
40 Aerosol container assembly
100 Air vehicle
101 Airframe
102 Airframe body
103 Arm
104 Rotor
105 Motor
106 Camera
107 Leg
108 Small rotor
110 Flight control unit
112 Flight communication unit
210 Mounted device control unit
211 Mounted device power supply
212 Mounted device communication unit
120 Maneuvering terminal
160 Operating terminal
163 Discharge button
164 Stop button
167 Display
M Rotation axis
N Container centerline
X Roll axis
Y Pitch axis
Z Yaw axis
Embodiment 2 (FIGS. 6 and 7)
201 Discharge apparatus
990 Rotary support unit
980 Motor
981 Support member
981c Flange
992 Support box
992a Base plate part
992b End plate part
992c Side plate part
993 Rotary bearing
V Turning axis
Embodiment 3 (FIG. 8)
301 Discharge apparatus
317 Two-way swivel pipe joint
3171 First joint member
3172 Second joint member
3173 Joint body part
M1 First rotation axis
M2 Second rotation axis
3191 First support frame
3192 Second support frame
3193 Motor support part
318A First motor
318B Second motor
Embodiment 4 (FIG. 9)
414 Actuator
a Offset amount
Embodiment 5 (FIGS. 10 and 11)
501 Discharge apparatus
514 Actuator
5181 Support frame
5181a First support part
5181b Second support part
70 Snap lock
71 Lock main body
72 Lever
73 Snap ring
74 Hook member
b Offset amount
Embodiment 6 (FIG. 12)
601 Discharge apparatus
981 Support member
981a First support portion
981b Second support portion
Embodiment 7 (FIG. 13)
601 Discharge apparatus
981 Support member
981a First support portion
981b Second support portion
c Offset amount
Embodiment 8 (FIG. 14(A))
801 Discharge apparatus
814 Actuator
814a Flange portion
8181 Support member
330 Discharge driving unit
331 Pushing member
331a Engaging part
332 Driving part
850 Container supporting device
851 Holding member
Embodiment 9 (FIG. 14(B))
901 Discharge apparatus
852 Connection plate
Additional mechanisms (FIG. 15)
190 Camera
191 Holding member
193 Distance sensor
5141 First pipe portion
5142 Second pipe portion

1. A discharge apparatus for an air vehicle, the discharge apparatus discharging contents from an aerosol container mounted on an airframe through a nozzle, wherein the aerosol container is mounted on an exterior of the airframe and one end of the nozzle is supported by a discharge end part of the aerosol container via a pipe joint that allows the nozzle to rotate so as to be rotatable around at least one rotation axis.

2. The discharge apparatus for the air vehicle according to claim 1, wherein the discharge end part of the aerosol container is an actuator connected to a stem of the aerosol container.

3. The discharge apparatus for the air vehicle according to claim 1, wherein the nozzle has one rotation axis.

4. The discharge apparatus for the air vehicle according to claim 1, wherein the nozzle has two rotation axes whose directions are different from each other and that allow the nozzle to rotate in two directions.

5. The discharge apparatus for the air vehicle according to claim 1, wherein the rotation axis of the nozzle is set in a perpendicular direction with respect to a centerline of the aerosol container.

6. The discharge apparatus for the air vehicle according to claim 1, wherein the rotation axis of the nozzle is offset in a perpendicular direction with respect to a centerline of the aerosol container.

7. The discharge apparatus for the air vehicle according to claim 6, wherein the offset rotation axis of the nozzle is located outside a maximum-diameter portion of the aerosol container.

8. The discharge apparatus for the air vehicle according to claim 1, the discharge apparatus comprising driving means for rotating the nozzle.

9. The discharge apparatus for the air vehicle according to claim 1, wherein the aerosol container mounted on the airframe is supported with respect to the airframe so as to be rotatable around a turning axis in a direction parallel to a yaw axis, and the turning axis and the rotation axis of the nozzle are separated from each other by a predetermined distance.

10. The discharge apparatus for the air vehicle according to claim 9, the discharge apparatus comprising container driving means for driving the aerosol container to turn with respect to the airframe.

11. The discharge apparatus for the air vehicle according to claim 9, wherein the aerosol container is horizontally loaded such that a centerline of the aerosol container is arranged in a direction parallel to a roll axis of the airframe.

12. The discharge apparatus for the air vehicle according to claim 9, wherein the aerosol container is vertically loaded such that a centerline of the aerosol container is arranged in a direction parallel to a yaw axis of the airframe.

13. The discharge apparatus for the air vehicle according to claim 1, wherein the aerosol container is configured to be housed in a housing member.

14. The discharge apparatus for the air vehicle according to claim 13, wherein the housing member is provided with a discharge driving unit for causing contents of the aerosol container to be discharged.

15. The discharge apparatus for the air vehicle according to claim 14, wherein the discharge driving unit has a configuration in which, by moving a container main body of the aerosol container, a stem protruding from the container main body is pushed into the container main body so that the contents are discharged.

16. The discharge apparatus for the air vehicle according to claim 1, wherein the nozzle holds a camera.

17. The discharge apparatus for the air vehicle according to claim 1, wherein the nozzle holds a distance sensor.
